(19) United States
(12) Patent Application Publication
(10) Pub. No.: US 2006/0090652 A1
(43) Pub. Date: May 4, 2006

(54) Brewing arrangement for a coffee maker

(75) Inventor: Hansdieter Greiwe, Boxberg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: Niro-Plan AG, Aarburg (CH)

(21) Appl. No.: 11/247,454

(22) Filed: Oct. 11, 2005

(30) Foreign Application Priority Data
Nov. 4, 2004 (EP) 04 026 151.3

(51) Int. Cl. A47J 31/00

(52) U.S. Cl. 99/279

(57) ABSTRACT

A brewing arrangement (1) is provided for a coffee maker with a brewing cylinder (2) with a vertical cylinder axis, which can be sealed by a lower piston (5) and an upper piston (4). According to the invention, the lower piston and the upper piston are coupled to each other to form a double piston (3) and therefore can be moved together.

### BACKGROUND

The invention relates to a brewing arrangement, especially for a fully automatic coffee maker, with a brewing cylinder having a vertical cylinder axis, which can be closed by a lower piston and an upper piston.

Brewing arrangements for fully automatic coffee makers are already known in various configurations. For example, a coffee maker sold by the applicant is designed such that the lower piston is arranged at the lower end of the brewing cylinder when the coffee grounds are filled and when the coffee is brewed, and this piston can be moved to the upper end of the brewing cylinder until it is arranged approximately flush with the upper edge of the brewing cylinder for the ejection of the used coffee grounds. In this position, a scraper is activated, which ejects the used coffee grounds in the lateral direction into a used coffee grounds container arranged there.

For this known construction, the scraper is arranged on a pivotable coffee grounds filling funnel, which, after the ejection of the used coffee grounds, is positioned above the brewing cylinder, so that the coffee grounds—after lowering the lower piston to the lower end of the brewing cylinder—are distributed fairly uniformly in the brewing cylinder area forming the brewing chamber (above the lower piston). In order to finally seal this brewing chamber at the top during the brewing of the coffee, at first the filling funnel is moved laterally outwards with the scraper, so that the upper piston arranged above can be moved downwards freely into the brewing cylinder.

Although these known brewing arrangements are already very developed and function without any problems, there is still the need to provide the brewing arrangement itself and also the brewing method even more simply and to improve the brewing arrangement even more to the extent that the production costs and the maintenance costs are reduced.

### SUMMARY

This object is achieved for a brewing arrangement of the type named above, such that the lower piston and the upper piston are coupled to each other to form a double piston and therefore can be moved together.

In this way, first the essential advantage is produced that a common drive and a common control of the double piston according to the invention are possible, which significantly simplifies the design of the brewing arrangement. Because the two partial pistons of the double piston are connected rigidly to each other into a common unit and feature an equal spacing to each other in each phase of the brewing and cleaning process. There is also no disadvantages associated with this forced coupling. In contrast, this fixed allocation of these two partial pistons achieves a large number of additional advantages, which shall be described in more detail below.

The double piston can move between at least an upper coffee grounds dosing position, a middle brewing position, and a lower coffee ejection position, so that each individual processing step can be optimized such that the double piston is arranged in a certain vertical position relative to the brewing cylinder. Thus, the double piston seals, for example, a partial area of the brewing cylinder functioning as the brewing chamber essentially at the top and bottom in the brewing position; only lines allocated to the double piston for the inlet or outlet of brewing water, air, and/or coffee form breaks in this seal in a controlled manner.

However, it is also useful in the coffee grounds dosing position if the double piston seals the brewing cylinder at the top and bottom, which is enabled such that the brewing cylinder has a coffee grounds filling opening that can be sealed especially by the double piston. This coffee grounds filling opening is arranged in a peripheral wall of the brewing cylinder, so that, for a double piston located in the brewing position, it is closed either directly by the upper piston or by means of a seal attached at the top. First, this leads to less aroma loss, because the coffee grounds coming from an attached coffee grounds doser or an attached coffee grinder and connected to this opening are forcibly separated from the ambient air. Second, a layer of coffee grounds dust in the device is prevented, especially above the upper piston, because no coffee grounds can emerge from the coffee grounds doser or the coffee grinder through the coffee grounds filling opening.

In contrast, in the coffee grounds dosing position, the upper piston of the double piston is located above the coffee grounds filling opening and thus opens the area of the brewing cylinder between the upper piston and the lower piston for filling the coffee grounds into the later brewing chamber. In this position, because the upper piston also ensures that the brewing cylinder is sealed at the top, contamination of the brewing cylinder by means of falling particles can be prevented. And in the reverse direction, coffee grounds are also prevented from being led into peripheral areas of the brewing cylinder during filling of the brewing cylinder.

The sealing of the brewing cylinder at the top by the upper piston is also important for another reason: it is useful if the brewing cylinder has a cleaning agent filling opening, which is arranged especially in a peripheral area above the coffee grounds filling opening, so that the upper piston can also prevent cleaning agent from unintentionally falling into the brewing cylinder. In contrast, if the brewing cylinder or the brewing chamber is to be cleaned with a cleaning agent, then the double piston can be moved past the coffee grounds dosing position upwards into a cleaning agent dosing position. In this position, the cleaning agent is filled, the double piston is then moved downwards especially into the brewing position, and the cleaning process is performed.

Another essential aspect of the present invention is that, for ejecting the used coffee grounds, the double piston can be moved downwards at least partially out of the brewing cylinder into the coffee ejection position, so that the used coffee grounds can be ejected by a scraper arranged in the area underneath the brewing cylinder directly into a used coffee grounds container arranged in or under this area. The advantage of ejecting the used coffee grounds from beneath the brewing cylinder or downwards into a used coffee grounds container arranged underneath the brewing cylinder is primarily that this used coffee grounds container can be used simultaneously as a collection container for possible coffee residue or other particles deposited due to breaks in the seal.

In particular, if contaminants are for the most part prevented by the features described farther above, then this arrangement of the used coffee grounds container underneath the brewing cylinder and also the movement of the double piston out of the brewing cylinder area downwards into the coffee ejection position leads to the result that additional maintenance expense is reduced by the predefined collection region for contaminants. Finally, the brewing arrangement can be cleaned optimally by flooding the outer area, which leads to improved hygienic conditions.

Now, concerning the upper and lower pistons, these can be embodied in a way that is at least partially already known, as follows: the lower piston can have a filter element, through which the brewed coffee can be filtered, wherein it is useful if a coffee collection chamber for the filtered coffee connected to a coffee outlet line is arranged in the lower piston underneath the filter element. In contrast, the upper piston can have a brewing water inlet opening with a water distributing element arranged especially underneath this brewing water inlet opening and also, usefully, an air inlet opening for introducing compressed air, which filters out the brewed coffee, such that it forces the brewed coffee through the filter element arranged in the lower piston, where the filtered coffee is collected in the coffee collection chamber and leaves this chamber through the coffee outlet line. However, forcing the coffee out of the brewing chamber not only leads to filtering of the brewed coffee, but also to drying of the used coffee grounds, in that coffee possibly still remaining in the used coffee grounds is filtered out by means of air or compressed steam and also leaves the brewing chamber through the filter element, the coffee collection chamber, and the coffee outlet line. As a result, dried used coffee grounds are produced, which can be handled more easily as cakes of used coffee grounds and therefore can be removed more easily with the help of the scraper in the coffee ejection position from the top side of the lower piston. Used coffee grounds residue possibly remaining during ejection of the used coffee grounds can then be removed by spraying the filter screen and also the lower piston.

An essential advantage of this construction of the upper and lower piston can be achieved, in that the coffee outlet line runs from the collection chamber arranged in the lower piston upwards through the upper piston, so that all three connecting lines (coffee outlet, brewing water supply, and compressed air supply) extend essentially in the area above the upper piston, so that no supply lines, which would disturb, for example, the ejection of the used coffee grounds or which could otherwise become easily contaminated or defective in some way and therefore must be regularly cleaned accordingly, are necessary underneath the lower piston and especially in the area under the brewing cylinder.

In this way and through the design of the double piston according to the invention, one obtains overall a brewing arrangement with an extremely small overall height, which enables the design of small, compact, and efficient coffee makers.

### BRIEF DESCRIPTION OF THE DRAWINGS

Additional features and advantages of the present invention result from the following description of one embodiment with reference to the drawing; which show

FIG. 1 a side view of a brewing arrangement according to the invention for a coffee maker in an initial position;

FIG. 2 the brewing arrangement as shown in FIG. 1 with the double piston located in an upper coffee grounds dosing position;

FIG. 3 the brewing arrangement as shown in FIG. 1 with the double piston located in a middle brewing position during the brewing process;

FIG. 4 the brewing arrangement as shown in FIG. 1 in the middle brewing position already shown in FIG. 3 during filtering of the coffee; and

FIG. 5 the brewing arrangement as shown in FIG. 1 with the double piston located in a lower coffee ejection position.

### DETAILED DESCRIPTION OF THE PREFERRED EMBODIMENTS

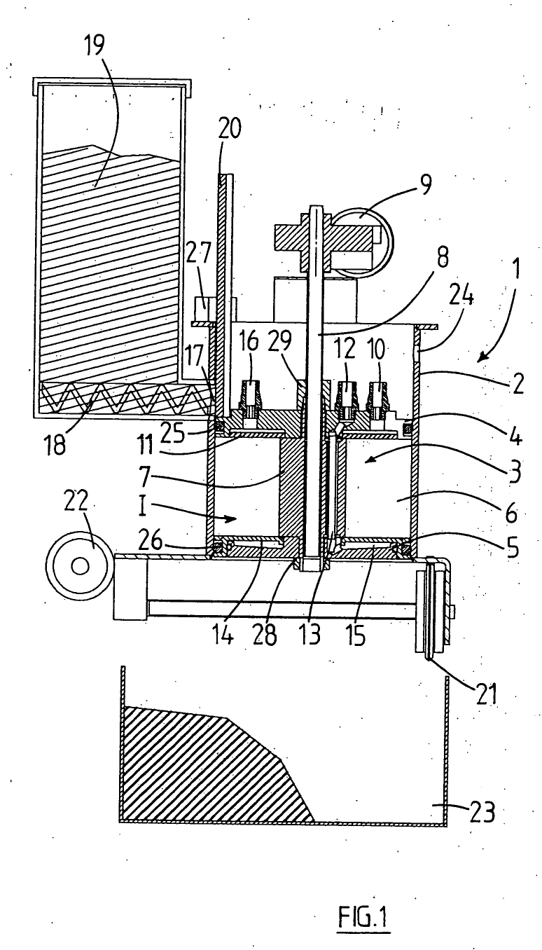

In FIG. 1, a brewing arrangement 1 is shown in side view, which has a tubular brewing cylinder 2 with a vertical cylinder axis and circular cross section, in which a double piston 3 is arranged so that it can move in the vertical direction. The double piston includes an upper piston plate 4 and a lower piston plate 5, which form between themselves a brewing chamber 6 enclosed by the brewing cylinder 2. The upper piston plate 4 and the lower piston plate 5 of the double piston 3 are connected and held fast to each other with a fixed spacing by a common threaded sleeve 7, wherein this threaded sleeve 7 carries a threaded spindle 8, which ensures the reciprocating movement of the double piston 3, in that it can be set in rotation by means of a geared motor 9 and thus moves the double piston in the vertical direction.

The upper piston plate 4 has a brewing water connection 10 for introducing the brewing water B through the upper piston plate into the brewing chamber 6 lying underneath, wherein the brewing water B leaving the brewing water connection 10 is distributed over the brewing chamber by a water distributing plate 11. In addition, a coffee outlet connection 12, which is connected to the lower piston plate 5 via a coffee outlet line 13, is provided in the upper piston plate 4.

This lower piston plate 5 has on its top side a filter film 14, which is used for filtering the brewed coffee. Finally, underneath the filter film 14 there is a coffee collection chamber 15 in the lower piston plate 5, which is connected to the coffee outlet line 13 and thus can transport the filtered coffee from the lower piston plate 5 through the coffee outlet line 13 and the coffee outlet connection 12.

In the present coffee maker construction the brewed coffee is transported as follows, the upper piston plate 4 has a compressed air line connection 16, through which compressed air can flow through the upper piston plate 4 into the brewing chamber and in this way can force the brewed coffee out of the brewing chamber by passing through the filter or the filter film 14 into the coffee collection chamber 15 and from there can be led out of the brewing cylinder via the coffee outlet line 13 into the cup of the person operating the coffee maker.

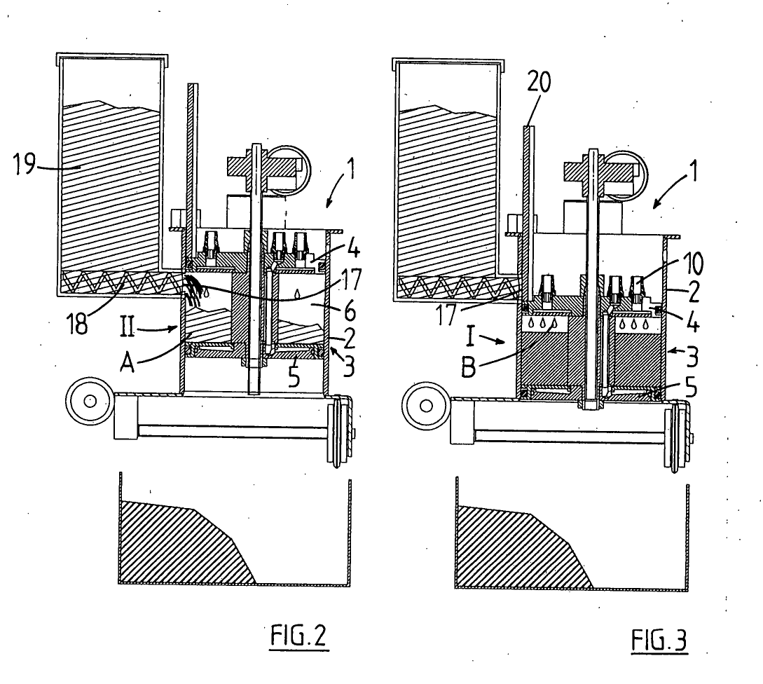

The additional details of the brewing arrangement according to the invention are described below for each processing step of the brewing method, wherein in each of the drawings, equivalent components are provided with the same reference numbers or, in FIGS. 2 to 5, only the components that are particularly relevant to the corresponding drawing are designated, while the remaining undesignated components correspond to the designations from FIG. 1.

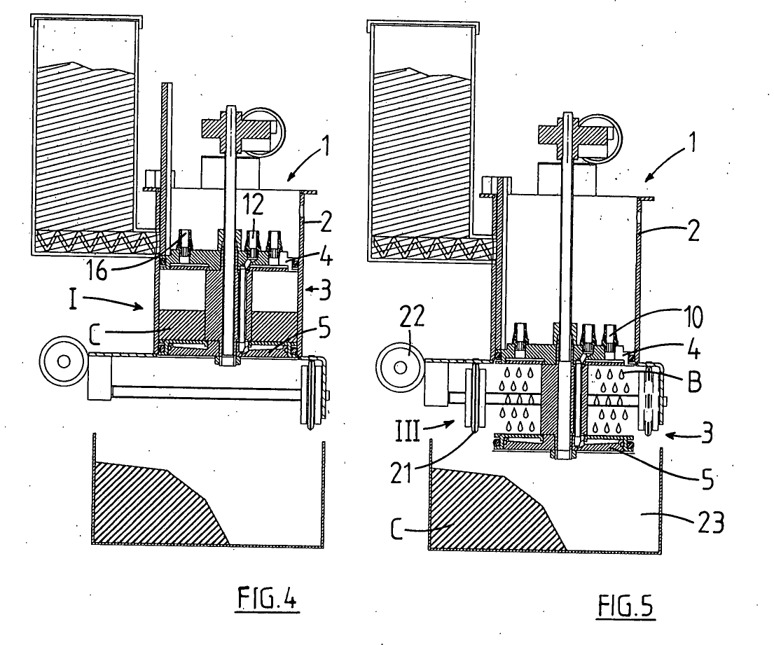

While FIG. 1 shows the initial position I of the double piston, which also corresponds in its height position to the processing steps from FIGS. 3 and 4, the double piston 3 in FIG. 2 is located in a coffee grounds dosing position II somewhat above the initial position I, that is, high enough that the upper piston plate 4 is arranged above a coffee grounds filling opening 17. This coffee grounds filling opening 17 connects a coffee grounds storage container 19 or a coffee grinder located in the same position to the brewing chamber 6 via a direct dosing unit 18 and ensures that no other components are loaded with the coffee grounds A and also that these components cannot be contaminated by the possible adhesion of coffee grounds.

After the dosing of the coffee grounds A into the brewing chamber 6, the double piston moves back downwards into the initial position I, which corresponds to the brewing position and is shown in FIG. 3. There, one can see how the coffee grounds filling opening 17 is closed especially without play by means of a closing surface 20 arranged on the upper piston plate 4, in order to prevent, on one hand, aroma loss and, on the other hand, contamination of the top side of the upper piston plate.

In the brewing position I according to FIG. 3, brewing water is guided into the brewing chamber 6 through the brewing water connection 10 and the brewing process is started according to the intended brewing time. After the desired brewing time has elapsed, compressed air is guided into the brewing chamber via the compressed air connection 16, the brewed coffee is fed through the filter film 14 into the coffee collection chamber 15, and from there it is fed to the coffee cup via the coffee outlet line 13 and the coffee outlet connection 12. While compressed air is fed to the brewing chamber, as shown in FIG. 4, not only is the brewed coffee filtered and led out of the brewing chamber, but also the used coffee grounds C deposited in the bottom area of the brewing chamber are simultaneously dried and formed into a cake of used coffee grounds.

Then the double piston 3 is moved from the brewing position 1 according to FIG. 4 into a lower coffee ejection position III according to FIG. 5, in which the bottom side of the upper piston plate 4 is flush with the lower edge of the brewing cylinder 2. A scraper 21 arranged underneath the brewing cylinder is moved in the horizontal direction by means of a separate motor 22 and scraps the used coffee grounds C from the filter film 14 of the lower piston plate 5 and ejects the used coffee grounds C into a used coffee grounds container 23 arranged underneath the brewing cylinder and the scraper. Then the filter film 14 is sprayed and cleaned with the help of the brewing water B that can be supplied via the brewing water connection 10. The scraper 21 moves back into its original position shown with dashed lines at the right in FIG. 5 and the double piston 3 moves into the initial position I shown in FIG. 1, in which the brewing arrangement is ready for the next brewing process.

In order to enable uniform scraping of the used coffee grounds with the help of the scraper 21, first the threaded sleeve 7, which connects the upper and the lower piston plate to each other is formed very flat in horizontal cross section in approximately an elliptical and horizontal cross direction, thus relative to the plane of the sheet of the drawing towards the front or back and the scraper 21 is formed in two parts, in order to be able to scrape the used coffee grounds C extending around the threaded sleeve 7 into two halves in front of and behind the threaded sleeve 7.

In the drawing, a cleaning agent filling opening 24 is still shown at the upper end of the brewing cylinder 2, which is separated in all of the positions of the double piston shown in the drawing by the upper piston plate 4 from the brewing chamber 6, which prevents loading of the brewing chamber with cleaning agent. Only when the double piston is to be moved into the (not shown) cleaning agent dosing position does the upper piston plate 4 extend above this cleaning agent filling opening 24 and enable the cleaning agent to enter the brewing chamber 6.

Finally, it should also be mentioned that the upper piston plate and the lower piston plate each contact the inner peripheral wall of the brewing cylinder 2 via O-ring seals 25, 26 and thus produce the desired sealing. In addition, a rotational locking device 27, which interacts with the closing diaphragm 20 and thus secures the rotational position of the double piston primarily during the vertical reciprocating movements, is arranged at the upper end of the brewing cylinder 2.

From the drawing, it can also be easily seen how the lower piston plate 5 is fixed to the central threaded sleeve 7 via a threaded nut 28 and the upper piston plate 4 is fixed to this threaded sleeve via a threaded nut 29, so that the entire double piston can be disassembled in a simple way, if individual parts must be exchanged, serviced, or repaired. This ability is most relevant for the exchange of the filter film 14: without requiring any guidance elements to be removed beforehand, very simply the lower threaded nut 28 is loosened and the lower piston plate 5 is pulled off of the double piston 3 and then the filter film 14 is openly accessible and can be exchanged.

To summarize, the present invention offers the advantages of not having to provide two pistons that move and are controlled separately from each other through the use of one double piston. The double piston forms a predefined brewing chamber, which—according to the processing step—is either sealed completely from the surroundings or is turned towards the coffee ground filling opening or can extend, for example, underneath the brewing cylinder, in order to be contacted there by a scraper. In this way, the double piston must be controlled only in one respect (thus virtually with only one degree of freedom), namely assuming a different vertical position according to the processing step, while the other functions necessary for brewing can be performed either automatically, for example, through forced or automatic closing of the coffee grounds filling opening, or can be coupled without problem to the corresponding vertical position of the double piston specific to the control, such as, for example, scraping when reaching the coffee ejection position.

In addition, because the contamination of the overall brewing arrangement can be significantly reduced or the contaminated area can be limited to the area of the used coffee grounds container, the maintenance costs and expenses can also be reduced. The same applies, for example, to filter replacements, which can be performed very simply by unscrewing the lower piston plate, without requiring the prior removal of any control or flow lines. Accordingly, underneath the lower piston plate there is only the scraper and the used coffee grounds container, so that additional possibilities for failures are also excluded due to the lack of sensitive components in this wet area. Finally, the low overall height of the brewing arrangement according to the invention enables the design of small, compact, and efficient coffee makers.

1. Brewing arrangement for a coffee maker comprising a brewing cylinder (2) with a vertical cylinder axis, which can be sealed by a lower piston (5) and an upper piston (4), the lower piston and the upper piston form a double piston, with the pistons being set with a fixed spacing relative to each other and moving together.

2. Brewing arrangement according to claim 1, wherein the double piston (3) is moveable between at least an upper coffee grounds dosing position (II), a middle brewing position (I), and a lower coffee ejection position (III).

3. Brewing arrangement according to claim 2, wherein the double piston (3) generally seals a partial area of the brewing cylinder (2) acting as a brewing chamber (6) at a top and bottom thereof in the brewing position (I).

4. Brewing arrangement according to claim 2, wherein the double piston (3) generally seals the brewing cylinder (2) at the top and the bottom in the coffee grounds dosing position (II).

5. Brewing arrangement according to claim 1, wherein the brewing cylinder (2) has a coffee grounds filling opening (17) that is sealable by the double piston (3).

6. Brewing arrangement according to claim 1, wherein the double piston (3) can move downwardly at least partially out of the brewing cylinder (2) into the coffee ejection position (III) for ejecting used coffee grounds (C).

7. Brewing arrangement according to claim 6, wherein a scraper (21) is arranged and can be activated in an area underneath the brewing cylinder (2).

8. Brewing arrangement according to claim 5, wherein the brewing cylinder (2) has a cleaning agent filling opening (24), which is arranged in a peripheral area above the coffee grounds filling opening (17).

9. Brewing arrangement according to claim 8, wherein the double piston (3) can move upwardly into a cleaning agent dosing position above the coffee grounds dosing position (II).

10. Brewing arrangement according to claim 1, wherein the lower piston (5) includes a filter element (14), through which the brewed coffee can be filtered, and that in the lower piston, underneath the filter element there is a coffee collection chamber (15) connected to a coffee outlet line (13) for the filtered coffee.

11. Brewing arrangement according to claim 10, wherein the coffee outlet line (13) runs upwards through the upper piston (4) from the coffee collection chamber (15) arranged in the lower piston (5).

12. Brewing arrangement according to claim 1, wherein the upper piston (4) includes a brewing water inlet opening (10) and/or a water distributing element (11).

13. Brewing arrangement according to claim 1, wherein the upper piston (4) has an air inlet opening (16) for filtering the brewed coffee via use of compressed air and steam and for drying the used coffee grounds.
